(19) United States
(12) Patent Application Publication
(10) Pub. No.: US 2007/0120675 A1
(43) Pub. Date: May 31, 2007

(54) SSB response method of RFID tag

(75) Inventors: Ji-hun Koo, Yongin-si (KR); Woo-shik Kang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/515,724

(22) Filed: Sep. 6, 2006

(30) Foreign Application Priority Data
Nov. 29, 2005 (KR) 10-2005-114966

(51) Int. Cl. G08B 13/14

(52) U.S. Cl. 340/572.2

(57) ABSTRACT

A single side band (SSB) response method of a radio frequency identification (RFID) tag receives a double side band (DSB) response signal whose frequency band is shifted from the RFID tag by shifting an SSB frequency band after transmitting an SSB command signal to an RFID tag. Even though the reader uses the SSB frequency band, the reader can receive a stable DSB response signal from the RFID tag.

### CROSS-REFERENCE TO RELATED APPLICATIONS

This application claims priority from Korean Patent Application No. 10-2005-0114966, filed Nov. 29, 2005 in the Korean Intellectual Property Office, the entire contents of which are incorporated herein by reference.

### BACKGROUND OF THE INVENTION

1. Field of the Invention

The present invention relates to a single side band (SSB) response method of a radio frequency identification (RFID) tag. More particularly, the present invention relates to sending an SSB command from a reader to an RFID tag and receiving a double side band (DSB) response signal from the RFID tag by shifting a frequency band of the reader after transmitting the SSB command signal.

2. Description of the Related Art

In an RFID system, a frequency is divided into a number of channels necessary to prevent RFID readers from interfering with each other in the multi-reader environment.

When a frequency band of 908.5˜914 MHz is used and each channel has a bandwidth of 200 KHz, 27 channels can be used.

When using a channel with this bandwidth, a reader performs a transmit mask of transmission data to prevent interference with another channel. That is, the transmit mask is performed in 0 dB channel for 0 channel, −20 dB channel for the first channel CH 1 and the first reverse channel CH −1, −50 dB channel for the second channel CH 2 and the second reverse channel CH −2, −60 dB channel for the third channel CH 3 and the third reverse channel CH −3, −65 dB channel for the fourth channel CH 4 and the fourth reverse channel CH −4 based on a middle frequency. The transmit mask is performed similarly for other transmission channels.

The reader receives data according to the channel selectivity set forth in the following Table 1 so as not to interfere with another channel.

TABLE 1

| Communications | Channel | | |
|---|---|---|---|
| environment | selectivity | Channel separation | Reference |
| Multi-reader | 5 dBc | 1 channel | ±1 channel adjacent to channel in use |
| | 35 dBc | 2 channel | ±2 channel adjacent to channel in use |
| | 45 dBc | 3 channel | ±3 channel adjacent to channel in use |
| | 55 dBc | 4 channel or more | ±4 channel or more adjacent to |
| | | | channel in use |
| Dense reader | 18 dBc | 1 channel | ±1 channel adjacent to channel in use |
| | 47 dBc | 2 channel or more | ±1 channel or more adjacent to |
| | | | channel in use |

An RFID reader in the ultra high frequency (UHF) band uses multiple channels in a frequency region, selects a desired channel and communicates with an RFID tag using DSB amplitude shift keying (ASK) or SSB ASK.

FIGS. 1A and 1B illustrate frequency spectra of a command signal and a response signal when a conventional reader uses DSB transmission.

FIG 1A illustrates a frequency spectrum of a command signal transmitted from the reader to the RFID tag, and FIG. 1B illustrates a frequency spectrum of a response signal transmitted from the RFID tag to the reader.

In the UHF RFID standards, a link frequency between a reader and an RFID tag is 40 KHz based on a carrier frequency (CF) as shown in FIGS. 1A and 1B. If the link frequency is over 40 KHz, it is difficult to maintain the 200 KHz transmit mask.

The response signal of the RFID tag is ±40 KHz apart from the CF. Accordingly, if the response signal of the RFID tag is more than 40 KHz away from a CF, the response signal can be received by an adjacent channel, thereby violating channel selectivity.

The reader may use SSB transmission instead of DSB transmission to raise a transmission rate of the command signal as shown in FIGS. 1C and 1D. FIG. 1C illustrates a frequency spectrum of a SSB command signal from the reader, and FIG. 1D illustrates a frequency spectrum of a DSB signal from the RFID tag in response to the SSB command signal.

As illustrated in FIG. 1C, when a reader uses SSB transmission, a frequency band of (40 KHz+α) within the 200 KHz transmit mask for a carrier frequency CF′ can be used.

However, the RFID tag transmits a DSB signal to the reader when responding to the SSB command signal from the reader, as illustrated in FIG 1D.

Therefore, the DSB response signal is ±40 KHz apart from the carrier frequency CF′ as illustrated in FIG. 1D so that an adjacent channel can recognize the response signal CF′−40 KHz. Accordingly, the DSB response signal violates channel selectivity.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an SSB response method of sending an SSB command from a reader to an RFID tag and receiving a DSB response signal from the RFID tag by shifting a frequency band of the reader after transmitting the SSB command signal.

According to an aspect of the present invention, there is provided an SSB response method of a radio frequency identification (RFID) tag, comprising transmitting an SSB command signal to an RFID tag, shifting a frequency band of the SSB command signal and receiving a DSB response signal from the RFID tag.

In the transmitting the SSB command signal, the SSB command signal is (40 KHz+α) apart from a carrier frequency to a higher frequency band.

The frequency band of the SSB command signal is within the 200 KHz transmit mask. The SSB command signal is a signal which is shifted within 200 KHz transmit mask from the original DSB signal to a lower frequency band as much as a certain frequency band.

In the shifting the frequency band of the SSB command signal, the frequency band in use is shifted to an upper frequency band as much as a certain frequency band. In receiving the DSB response signal from the RFID tag, the DSB response signal is 40 KHz apart from the carrier frequency to a higher frequency band and 40 KHz apart from the carrier frequency to a lower frequency band.

According to an aspect of the present invention, there is provided a radio frequency identification (RFID) reader comprising a list writer which writes a pulse width list when a signal is transmitted to an RFID tag and writes an available pulse width list corresponding to a response signal when the response signal is received from the RFID tag, a controller which interprets the signal received from the RFID tag, generates a command signal, transmits the command signal to the RFID tag using an SSB frequency band, and shifts the frequency band in use in order for a DSB response signal from the RFID tag to be received within the frequency band in use right after transmitting the command signal to the RFID tag, and a transmission/reception unit which receives the response signal from the RFID tag and transmits the command signal to the RFID tag.

The RFID reader further comprises an RF circuit which shifts the frequency band in use according to a shift command of the frequency band in use from the controller and transmits the shifted frequency band to the transmission/reception unit, a transmission filter which filters the command signal generated from the controller and transmits the command signal to the RF circuit, a reception filter which filters the response signal received from the RFID tag and transmits the response signal to the controller, and a storage which stores the pulse width list and/or the available pulse width list which are written in the list writer.

The controller shifts the frequency band in use to an upper frequency band as much as a certain frequency band.

The controller receives the DSB response signal , which is 40 KHz apart from the carrier frequency to a higher frequency band and by 40 KHz from the carrier frequency to a lower frequency band, through the transmission/reception unit.

### BRIEF DESCRIPTION OF THE DRAWING FIGURES

The above and other aspects of the present invention will become more apparent by describing in detail exemplary embodiments thereof with reference to the attached drawing figures, wherein;

FIGS. 1A and 1B illustrate frequency spectra of a command signal and a response signal when a conventional reader uses DSB transmission;

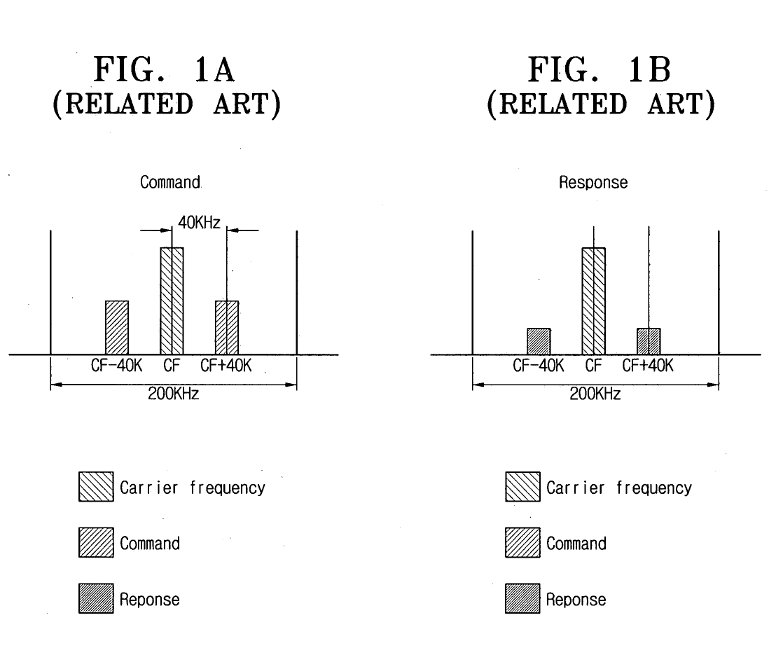

FIGS. 1C and 1D illustrate frequency spectra of a convention SSB command signal and a conventional DSB response signal;

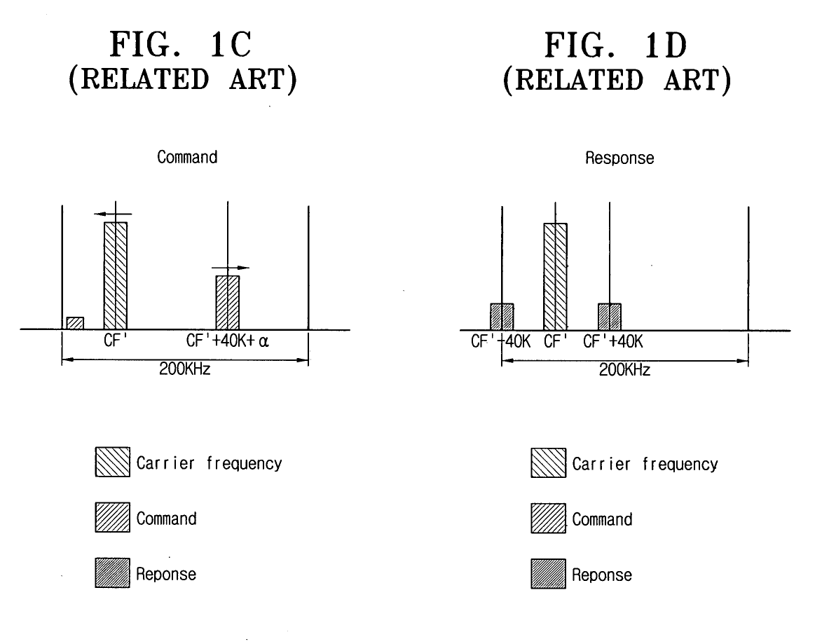

FIGS. 2A and 2B illustrate frequency spectra to describe a basic concept of an SSB response method of an RFID tag according to an exemplary embodiment of the present invention;

FIG. 3 schematically illustrates a configuration of a reader according to an exemplary embodiment of the present invention; and

FIG. 4 illustrates a command signal of a reader and a response signal of an RFID tag in an SSB response method of an RFID tag according to an exemplary embodiment of the present invention.

### DETAILED DESCRIPTION OF THE EXEMPLARY EMBODIMENTS

Hereinafter, an exemplary embodiment of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

First, an RFID tag system will be described to understand the present invention.

An RFID tag can be used, for example, for tracking inventory of goods in stock, for an automatic selection device related to fee collection for tollgates, for security systems, and for electronic cards. Additionally, as an RFID tag is readable through paint, water, waste, dust, human and animal bodies, concrete or the item to which the tag is attached, RFID tags are being used in much harsher environments than bar code labels. The RFID tag is used with an RF tag reader which generates a continuous wave radio frequency (CWRF) carrier to operate the RFID tag within the transmission range of the reader. The RFID tag may be a passive element having no power source. Therefore, the RFID tag uses power from the CWRF generation to operate an internal circuit for reading a digital code stored in the RFID tag. The RFID tag operates to transmit the digital code to the tag reader by a radio signal.

The RFID tag varies the amplitude of the continuous wave (CW) carrier of the reader by loading or unloading a resonance circuit tuned for the CW frequency. For example, the RFID tag may include a parallel resonance circuit tuned for a frequency of the CWRF carrier and an RF antenna, a direct current (DC) converter to convert an RF signal into DC, a circuit to load or unload the parallel resonance circuit and RF antenna, and logic to store and read the internal digital code. The RFID tag operates the internal digital code together with the circuit to load or unload the parallel resonance circuit and RF antenna.

In the RFID tag, as power of the logic circuit and sensor is induced in the direct current, a circuit to convert the alternating current (AC) into the DC, such as the CWRF and UHF/microwave, is formed.

When within range of the tag reader, the RFID tag loads the tuning circuit so that the voltage amplitude of the tuning circuit decreases. If the tuning circuit in the RFID tag gets out of a resonance state by an internal circuit, the RFID tag does not load the tuning circuit and the voltage amplitude of the tuning circuit increases again up to the voltage amplitude previously when the RFID tag is adjacent to the tag reader. Accordingly, the RFID tag varies the amplitude of the tuning circuit to transmit DC data word bit stream information having an on/off pulse signal. The tag reader senses the amplitude variation of such CWRF so as to change the information from the RFID tag into the on/off signal used in the DC data word bit stream.

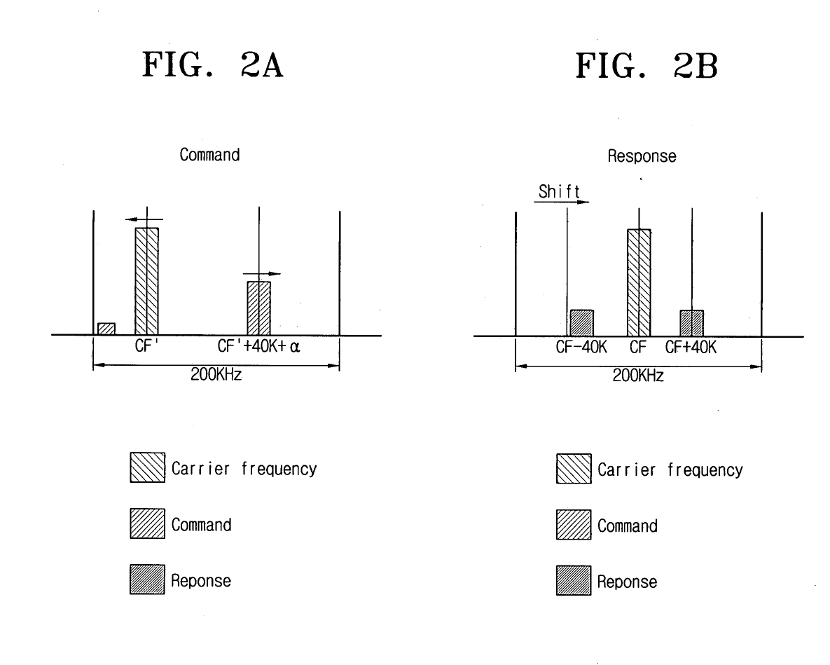

FIGS. 2A and 2B illustrate frequency spectra to describe a basic concept of an SSB response method of an RFID tag according to an exemplary embodiment of the present invention.

FIG. 2A illustrates a frequency spectrum of a command signal from the reader to the RFID tag and FIG. 2B illustrates a frequency spectrum of a response signal from the RFID tag to the reader.

In the exemplary embodiment of the present invention, the reader transmits an SSB command signal as shown in FIG. 2A within the 200 KHz transmit mask, and subsequently shifts the frequency band in use as shown in FIG. 2B, so that a DSB response signal can be within the frequency band in use. Accordingly, the DSB response signal is within the frequency band in use and therefore does not interfere with another channel.

As shown FIG. 2A, the SSB command signal which the reader transmits to the RFID tag is (40 KHz+α) apart from the CF′. Here, α is an integer. The response signal which the reader receives from the RFID tag is ±40 KHz apart from the CF.

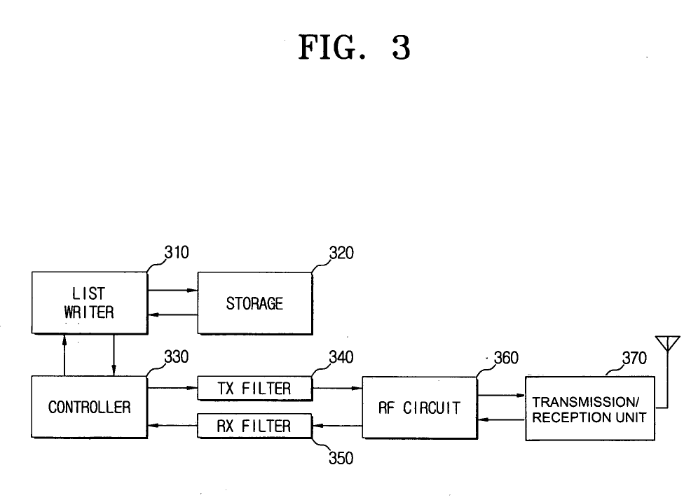

FIG. 3 schematically illustrates a configuration of a reader according to an exemplary embodiment of the present invention.

The reader according to an exemplary embodiment of the present invention may include a list writer 310, storage 320, a controller 330, a transmission filter 340, a reception filter 350, an RF circuit 360 and a transmission/reception unit 370.

The list writer 310 writes a pulse width list which is a list of the pulse widths when a signal is transmitted to the RFID tag, and writes an available pulse width list which is a list of the pulse widths corresponding to a response signal when the response signal is received from the RFID tag.

The storage 320 stores the pulse width list and/or the available pulse width list written in the list writer 310.

The controller 330 interprets the signal received from the RFID tag and accordingly generates and transmits a command signal to the RFID tag. When receiving the response signal from the RFID tag or transmitting the command signal to the RFID tag, the controller 330 uses the SSB frequency band. After transmitting the command signal to the RFID tag, the controller 330 shifts the frequency band in use as shown in FIG. 2B so that the DSB response signal received from the RFID tag is received within the frequency band in use.

The transmission filter 340 filters a command signal generated from the controller 330 and transmits the command signal to the RF circuit 360. The reception filter 350 filters the response signal received from the RFID tag and transmits the response signal to the controller 330.

The RF circuit 360 functioning as a frequency mixer shifts the frequency band in use according to a shift command of the frequency band in use from the controller 330 as shown in FIG. 2B and transmits the shifted frequency band to the transmission/reception unit 370.

The transmission/reception unit 370 receives the response signal from the RFID tag to transmit to the RF circuit 360 or transmits the command signal from the controller 360 to the RFID tag.

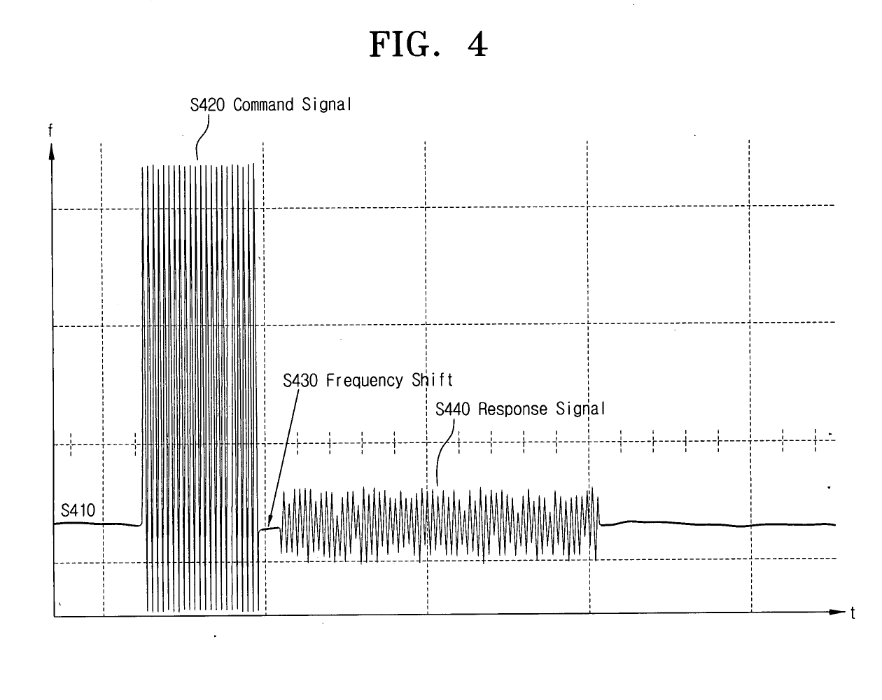

FIG. 4 illustrates a command signal of a reader and a response signal of an RFID tag in an SSB response method of an RFID tag according to an exemplary embodiment of the present invention.

First, the reader writes a pulse width list of a command signal to stepwise transmit according to the communications environment through the list writer 310.

The pulse width list can be set according to a certain interval from the default value and the certain interval can be an allowable error range of a critical signal pulse width. In this case, the number of a pulse width on the written pulse width list is ‘N’ and the written pulse width list is stored in the storage 320.

The reader transmits the CW to the RFID tag in the SSB frequency band in use (S410). The CW loads or unloads the resonance circuit of the RFID tag by making the resonance circuit of the RFID tag tuned with the CW.

Subsequently, the reader transmits an SSB command signal to the RFID tag (S420).

The reader transmits a command signal CF′+40 KHz+α, which is (40 KHz+α) apart from CF′ to a higher frequency band, to the RFID tag within the 200 KHz transmit mask as shown in FIG. 2A.

The SSB command signal is a signal which is shifted from the original DSB signal to a lower frequency band as much as a certain frequency band within the 200 KHz of the transmit mask.

The reader, which has transmitted the SSB command signal, shifts the frequency band in use to a higher frequency band as much as a certain frequency band in order to receive a normal DSB response signal from the RFID tag within the 200 KHz frequency band (S430).

Therefore, the RFID tag receives the SSB command signal shifted a certain frequency band-higher than would usually be received from the reader.

Next, the RFID tag transmits a response signal to the reader using the backscattering method if the received command signal is right for a condition. As receiving the SSB command signal shifted to a higher frequency band as much as a certain frequency band from the reader, the RFID tag also transmits DSB response signal shifted to a higher frequency band as much as a certain frequency band to the reader as illustrated in FIG. 2B (S440).

Accordingly, the reader receives a response signal which is ±40 KHz apart from the carrier frequency CF within the 200 KHz bandwidth as shown in FIG. 2B. When the reader receives the response signal from the RFID tag, the corresponding pulse width is stored as an available pulse width in the storage 320.

Thus, even though the reader transmits an SSB command signal to the RFID tag, the reader can receive a stable DSB response signal, which does not violate channel selectivity and interfere with an adjacent channel, from the RFID tag.

As can be appreciated from the above description, although the reader according to exemplary embodiments of the present invention uses the SSB frequency band, the reader can receive a stable DSB response signal, which does not interfere with an adjacent channel, from the RFID tag. Furthermore, a RFID system which does not violate channel selectivity and can be applied to domestic standards can be implemented.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A single side band (SSB) response method of a radio frequency identification (RFID) tag, the method comprising:
transmitting an SSB command signal to an RFID tag;
shifting an SSB frequency band; and
receiving a double side band (DSB) response signal, of which a frequency band is shifted, from the RFID tag.

2. The method of claim 1, wherein in the transmitting the SSB command signal to the RFID tag, the SSB command signal is (40 KHz+α) apart from a carrier frequency to a higher frequency band, where a is an integer.

3. The method of claim 1, wherein a frequency band of the SSB command signal is within a 200 KHz transmit mask.

4. The method of claim 2, wherein a frequency band of the SSB command signal is within a 200 KHz transmit mask.

5. The method of claim 1, wherein the SSB command signal is shifted from the DSB signal to a lower frequency band by a certain frequency band within a 200 KHz transmit mask.

6. The method of claim 2, wherein the SSB command signal is shifted from the DSB signal to a lower frequency band by a certain frequency band within a 200 KHz transmit mask.

7. The method of claim 1, wherein in the shifting the SSB frequency band, the frequency band in use is shifted to an upper frequency band by a certain frequency band.

8. The method of claim 1, wherein in the receiving the DSB response signal, the DSB response signal is 40 KHz apart from the carrier frequency to a higher frequency band and 40 KHz apart from the carrier frequency to a lower frequency band.

9. A radio frequency identification (RFID) reader, comprising:
a list writer which writes a pulse width list if a signal is transmitted to an RFID tag, and writes an available pulse width list corresponding to a response signal if the response signal is received from the RFID tag;
a controller which interprets the signal received from the RFID tag, generates a command signal, transmits the command signal to the RFID tag using a single side band (SSB) frequency band, and shifts the frequency band in use after transmitting the command signal to the RFID tag; and
a transmission and reception unit which receives the response signal from the RFID tag, and transmits the command signal to the RFID tag.

10. The RFID reader of claim 9, further comprising:
a radio frequency (RF) circuit which shifts the frequency band in use according to a shift command of the frequency band in use from the controller and transmits the shifted frequency band to the transmission/reception unit;
a transmission filter which filters the command signal generated from the controller and transmits the command signal to the RF circuit;
a reception filter which filters the response signal received from the RFID tag and transmits the response signal to the controller; and
a storage which stores at least one of the pulse width list and the available pulse width list which are written by the list writer.

11. The RFID reader of claim 9, wherein the command signal is (40 KHz+α) apart from a carrier frequency to a higher frequency band, where a is an integer.

12. The RFID reader of claim 11, wherein a frequency band of the SSB command signal is within a 200 KHz transmit mask.

13. The RFID reader of claim 11, wherein the SSB command signal is shifted from a double side band (DSB) signal to a lower frequency band by a certain frequency band within the 200 KHz transmit mask.

14. The RFID reader of claim 9, wherein the controller shifts the frequency band in use to an upper frequency band by a certain frequency band.

15. The RFID reader of claim 9, wherein the controller receives the DSB response signal which is 40 KHz apart from the carrier frequency to a higher frequency band and 40 KHz apart from the carrier frequency to a lower frequency band, through the transmission and reception unit.
